(19) United States
(12) Patent Application Publication
(10) Pub. No.: US 2019/0162692 A1
(43) Pub. Date: May 30, 2019

(54) ARRAY SENSING ELECTRODE, MANUFACTURING METHOD THEREOF AND SENSING PLATFORM

(71) Applicant: Akubic (Cayman) Limited, Grand Cayman (KY)

(72) Inventors: Kuan-Jung Chen, Taipei City (TW); Yu-Cheng Liu, Taipei City (TW); Pin-Hsuan Lin, Taipei City (TW); Shih-Hao Ko, Taipei City (TW); Hsiao-Han Yu, Taipei City (TW)

(21) Appl. No.: 15/905,627

(22) Filed: Feb. 26, 2018

(30) Foreign Application Priority Data
Nov. 24, 2017 (TW) 106141064

(51) Int. Cl. G01N 27/333; G01N 27/30; G01N 27/413

(52) U.S. Cl. CPC G01N 27/333; G01N 27/304; G01N 27/413; G01N 27/301

(57) ABSTRACT

An array sensing electrode includes an electric insulating base plate, a plurality of electric conductive assemblies, a reference sensing layer, at least a chemical sensing layer, and an electrolyte layer. The electric insulating base plate has a plurality of perforations. Each electric conductive assembly includes an electric conductive filler, a first electric conductive part, and a second electric conductive part. The electric conductive filler is penetrated through the perforation, and the first electric conductive part and the second electric conductive part are disposed on a first plane and a second plane of the electric conductive filler, respectively. The reference sensing layer and the chemical sensing layer are disposed on different first electric conductive parts, and the electrolyte layer is disposed on the reference sensing layer and the chemical sensing layer to cover thereon. Therefore, the advantages of decreasing the manufacture cost and being conductive to packaging are achieved.

### CROSS-REFERENCE TO RELATED APPLICATION

This application claims priority to Taiwan Patent Application No. 106141064, filed on Nov. 24, 2017, the entire contents of which are incorporated herein by reference for all purposes.

### FIELD OF THE INVENTION

The present invention relates to a sensing electrode, and more particularly to an array sensing electrode, a manufacturing method thereof and a sensing platform.

### BACKGROUND OF THE INVENTION

In modern society, the chemical sensing devices with chemical sensing electrodes are widely used in various industries, such as biomedical, chemical, agricultural and environmental technology fields. For example, chemical sensing electrodes may be applied to water quality monitoring devices to provide instant insight to the effectiveness of water treatment and changes in water quality, thereby facilitating the operation of preventative or immediate improvements in treatment procedures.

The glass electrodes are used as ion sensing electrodes in the traditional chemical sensing devices. Although the glass electrodes may stably monitor the ion concentration, the structures thereof are complicated, the costs are expensive, and are also not conducive to miniaturization. Moreover, limited to the structures of the glass electrodes and the reference electrodes in the chemical sensing devices, the sensing sensitivity is not effective to be enhanced.

In prior arts, the planar sensing electrodes are also be used, so as to sense and analyze target ions. However, since the electrode connection areas and the chemical sensing areas of the planar sensing electrodes are located on the same plane, the size of the sensing electrodes are larger, and more electrode materials are consumed, resulting in higher manufacturing costs. In addition, the planar sensing electrodes are more difficult to be packaged and are not conducive to the application of wearable or water immersion chemical sensing devices.

Therefore, there is a need of providing an array sensing electrode, a manufacturing method thereof and a sensing platform to enhance the sensitivity of the chemical sensing, and reduce the size and volume of the electrode, such that the advantages of reducing the manufacturing cost and being conductive to the packaging are achieved.

### SUMMARY OF THE INVENTION

It is an object of the present invention to provide an array sensing electrode, a manufacturing method thereof and a sensing platform in order to solve the drawbacks of prior art.

The present invention provides an array sensing electrode, a manufacturing method thereof and a sensing platform. Through making the electric conductive fillers of the plurality of electric conductive assemblies to be penetrated through the electric insulating base, and disposing the reference sensing layers and the chemical sensing layers on the electric conductive assemblies, the sensitivity of the chemical sensing is enhanced, the manufacture is simplified, and the size of the electrode is reduced.

The present invention also provides an array sensing electrode, a manufacturing method thereof and a sensing platform. By making the plurality of electric conductive fillers to be penetrated through the plurality of perforations of the electric insulating base, disposing the first electric conductive part, which is used to dispose the sensing layers, on the first plane of the electric conductive filler, and disposing the second electric conductive part connected to the control unit on the second plane of the electric conductive filler, the volume of the electrode is decreased, and the advantages of reducing the manufacturing cost and being conductive to the package are achieved.

The present invention also provides an array sensing electrode, a manufacturing method thereof and a sensing platform. Through disposing the plurality of identification elements in a one-to-one manner corresponding to the plurality of electric conductive assemblies on the second surface of the electric insulating base, so as to identify the electric conductive assemblies with different sensing layers while the sensing electrode is in operation.

The present invention also provides a sensing platform. By disposing a housing with a plurality of carrier channels, disposing the circuit board in the accommodation space of the housing, and embedding the array sensing electrodes in the plurality of carrier channels to be electrically connected to the control unit, the housing may carry a plurality of sensing electrodes, thereby being conducive to packaging and achieving waterproof effects.

In accordance with an aspect of the present invention, there is provided an array sensing electrode comprising an electric insulating base, a plurality of electric conductive assemblies, a reference sensing layer, at least a chemical sensing layer, and an electrolyte layer. The electric insulating base has a first surface, a second surface, and a plurality of perforations. The first surface and the second surface are on two opposite sides of the electric insulating base, and the first surface and the second surface are communicated by the plurality of perforations. Each electric conductive assembly comprises an electric conductive filler, a first electric conductive part, and a second electric conductive part. The electric conductive filler is penetrated through one of the plurality of perforations, and the electric conductive filler has a first plane and a second plane, which are on two opposite sides of the electric conductive filler. The first electric conductive part is disposed on the first plane of the electric conductive filler, and the second electric conductive part is disposed on the second plane of the electric conductive filler. The reference sensing layer is disposed on the first electric conductive part of one of the plurality of electric conductive assemblies, the chemical sensing layer is disposed on the first electric conductive part of at least another one of the plurality of electric conductive assemblies, and the electrolyte layer is disposed on and covering the reference sensing layer and the chemical sensing layer.

In accordance with an aspect of the present invention, there is provided a manufacture method of an array sensing electrode comprising steps of: (a) providing an electric insulating base, wherein the electric insulating base has a first surface, a second surface, and a plurality of perforations, wherein the first surface and the second surface are on two opposite sides of the electric insulating base, and the first surface and the second surface are communicated by the plurality of perforations; (b) making a plurality of electric conductive fillers to be penetrated through the plurality of perforations in a one-to-one manner and forming a plurality of first electric conductive parts and a plurality of second electric conductive parts on a first plane and a second plane of the plurality of electric conductive fillers, respectively, wherein the first plane and the second plane are on two opposite sides of the electric conductive filler; (c) forming a reference sensing layer on one of the first electric conductive parts and forming at least a chemical sensing layer on at least another one of the first electric conductive parts; and (d) forming an electrolyte layer to cover over the reference sensing layer and the chemical sensing layer.

In accordance with an aspect of the present invention, there is provided a sensing platform comprising a housing, a circuit board, a control unit, and a plurality of array sensing electrodes. The housing has an outer wall and a plurality of carrier channels, and the outer wall is closed to form an accommodation space in the housing. The circuit board is disposed in the accommodation space, and the control unit is disposed on the circuit board. Each of the array sensing electrodes is embedded in one of the plurality of carrier channels, and comprises an electric insulating base, a plurality of electric conductive assemblies, a reference sensing layer, at least a chemical sensing layer, and an electrolyte layer. The electric insulating base has a first surface, a second surface, and a plurality of perforations. The first surface and the second surface are on two opposite sides of the electric insulating base, and the first surface and the second surface are communicated by the plurality of perforations. Each electric conductive assembly comprises an electric conductive filler, a first electric conductive part, and a second electric conductive part. The electric conductive filler is penetrated through one of the plurality of perforations, and the electric conductive filler has a first plane and a second plane, which are on two opposite sides of the electric conductive filler. The first electric conductive part is disposed on the first plane of the electric conductive filler, and the second electric conductive part is disposed on the second plane of the electric conductive filler and electrically connected with the control unit. The reference sensing layer is disposed on the first electric conductive part of one of the plurality of electric conductive assemblies, the chemical sensing layer is disposed on the first electric conductive part of at least another one of the plurality of electric conductive assemblies, and the electrolyte layer is disposed on and covering the reference sensing layer and the chemical sensing layer.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the exploded structure of an array sensing electrode according to an embodiment of the present invention;

FIG. 2 schematically illustrates an array sensing electrode according to an embodiment of the present invention;

FIG. 3 schematically illustrates an array sensing electrode according to another embodiment of the present invention;

FIG. 4 schematically illustrates the flowchart of a manufacture method of an array sensing electrode according to another embodiment of the present invention;

FIG. 5 schematically illustrates the detailed flowchart of a manufacture method of an array sensing electrode according to another embodiment of the present invention;

FIG. 6 schematically illustrates a sensing platform according to an embodiment of the present invention;

FIG. 7 schematically illustrates the bottom view of the sensing platform as shown in FIG. 6; and

FIG. 8 schematically illustrates the exploded structure of the sensing platform as shown in FIG. 7.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

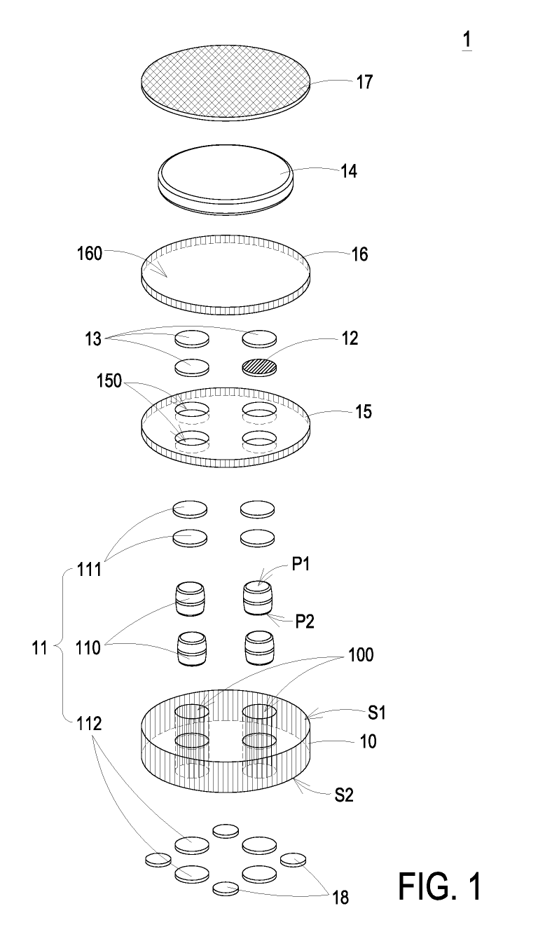

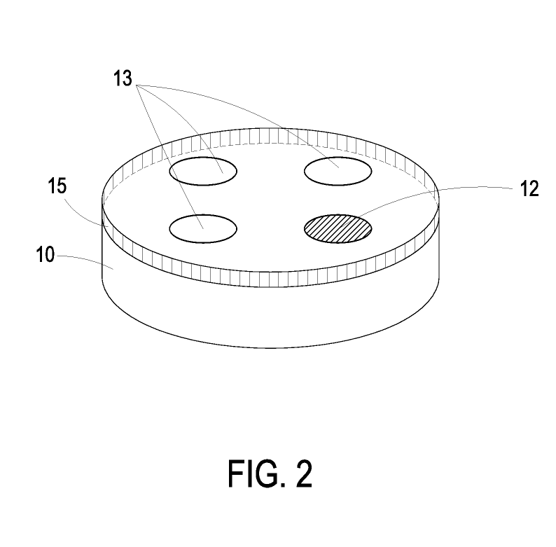

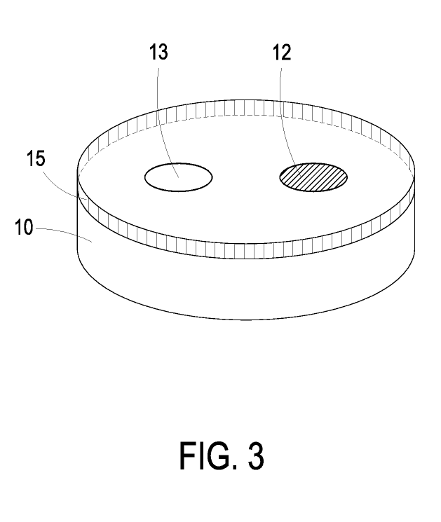

Please refer to FIG. 1, FIG. 2, and FIG. 3. FIG. 1 schematically illustrates the exploded structure of an array sensing electrode according to an embodiment of the present invention. FIG. 2 schematically illustrates an array sensing electrode according to an embodiment of the present invention. FIG. 3 schematically illustrates an array sensing electrode according to another embodiment of the present invention. As shown in FIG. 1, FIG. 2, and FIG. 3, the present invention provides an array sensing electrode 1 comprising an electric insulating base 10, a plurality of electric conductive assemblies 11, a reference sensing layer 12, at least a chemical sensing layer 13, and an electrolyte layer 14. The electric insulating base 10 has a first surface S1, a second surface S2, and a plurality of perforations 100. The first surface S1 and the second surface S2 are on two opposite sides of the electric insulating base 10, and the first surface S1 and the second surface S2 are communicated through the plurality of perforations 100. The electric insulating base 10 may be a polyethylene terephthalate (PET) base or ceramic base, but not limited herein.

Each electric conductive assembly 11 comprises an electric conductive filler 110, a first electric conductive part 111, and a second electric conductive part 112. The electric conductive filler 111 is penetrated through one of the plurality of perforations 100, and the electric conductive filler 111 has a first plane P1 and a second plane P2, which are on two opposite sides of the electric conductive filler 110. The first electric conductive part 111 is disposed on the first plane P1 of the electric conductive filler 110, and the second electric conductive part 112 is disposed on the second plane P2 of the electric conductive filler 110. In some embodiments, the first plane P1 of the electric conductive filler 110 is level to the first surface S1 of the electric insulating base 10, and the first plane P1 and the first surface S1 form a complete plane. Furthermore, the second plane P2 of the electric conductive filler 110 is level to the second surface S2 of the electric insulating base 10, and the second plane P2 and the second surface S2 form a complete plane, but not limited thereto.

The reference sensing layer 12 is disposed on the first electric conductive part 111 of one of the plurality of electric conductive assemblies 11, at least a chemical sensing layer 13 is disposed on the first electric conductive part 111 of at least another one of the plurality of electric conductive assemblies 11, among which each chemical sensing layer 13 is disposed corresponding to one of the plurality of electric conductive assemblies 11. The electrolyte layer 14 is disposed on and covering the reference sensing layer 12 and the chemical sensing layer 13.

In some embodiments, the array sensing electrode 1 further comprises an insulating waterproof layer 15 disposed on the first surface S1 of the electric insulating base 10. The insulating waterproof layer 15 has a plurality of apertures 150 corresponding to the plurality of perforations 100, such that the first electric conductive parts 111 are exposed outside the insulating waterproof layer 15.

In some embodiments, the array sensing electrode 1 further comprises a pad 16 disposed on the first surface S1 of the electric insulating base 10. The pad 16 has an opening 160, and the electrolyte layer 14 is accommodated in the opening 160 and contacted with the reference sensing layer 12 and the chemical sensing layer 13. In some embodiments, the array sensing electrode 1 further comprises a gas diffusion layer 17 disposed on and covering the electrolyte layer 14, and the gas diffusion layer 17 is attached to the pad 16, thereby holding the electrolyte layer 14 among the gas diffusion layer 17 and the reference sensing layer 12 and the chemical sensing layer 13.

In some embodiments, the array sensing electrode 1 further comprises a plurality of identification elements 18 disposed on the second surface S2 of the electric insulating base 10. The identification elements 18 are disposed in a one-to-one manner corresponding to the electric conductive assemblies 11, so as to perform identification to the electric conductive assemblies 11 with different sensing layers while the sensing electrode is in operation. For example but not limited to, by cooperating with specific electric conductive pin positions, and according to the current conduction or not, the purpose of identifying the conductive assemblies with different types of sensing layers is achieved.

In other words, in the array sensing electrode of the present invention, through making the electric conductive fillers of the plurality of electric conductive assemblies to be penetrated through the electric insulating base, and disposing the reference sensing layers and the chemical sensing layers on the electric conductive assemblies, the sensitivity of the chemical sensing is enhanced, the manufacture is simplified, and the size of the electrode is reduced. Furthermore, by making the plurality of electric conductive fillers to be penetrated through the plurality of perforations of the electric insulating base, disposing the first electric conductive part, which is used to dispose the sensing layers, on the first plane of the electric conductive filler, and disposing the second electric conductive part connected to the control unit on the second plane of the electric conductive filler, the volume of the electrode is decreased, and the advantages of reducing the manufacturing cost and being conductive to the package are achieved.

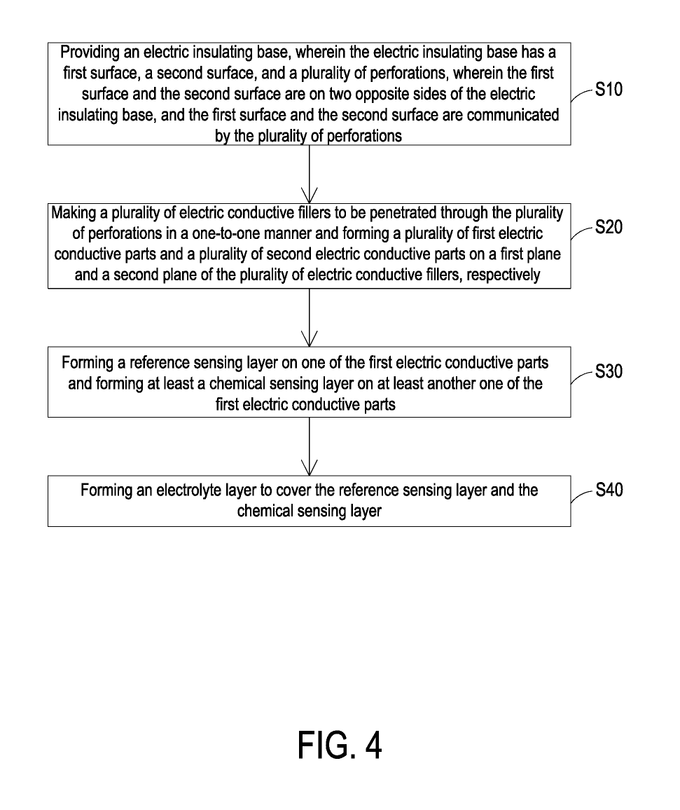

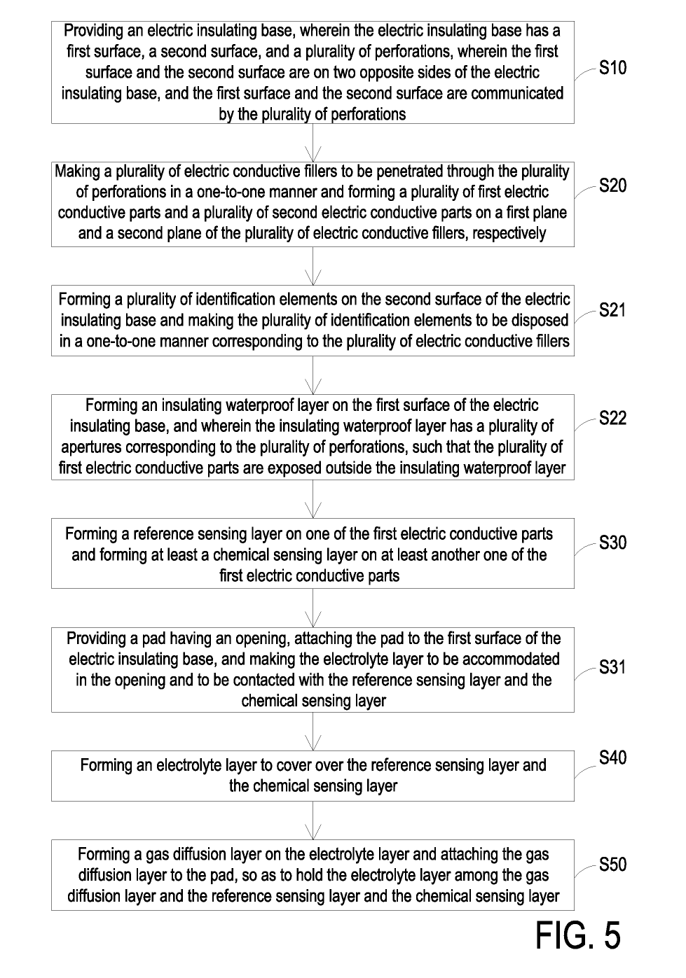

Please refer to FIG. 1, FIG. 4, and FIG. 5. FIG. 4 schematically illustrates the flowchart of a manufacture method of an array sensing electrode according to another embodiment of the present invention. FIG. 5 schematically illustrates the detailed flowchart of a manufacture method of an array sensing electrode according to another embodiment of the present invention. As shown in FIG. 1, FIG. 4, and FIG. 5, a manufacture method of an array sensing electrode 1 comprises steps as follows. First, in a step S10, an electric insulating base 10 is provided. The electric insulating base 10 has a first surface S1, a second surface S2, and a plurality of perforations 100, among which the first surface S1 and the second surface S2 are on two opposite sides of the electric insulating base 10, and the first surface S1 and the second surface S2 are communicated by the plurality of perforations 100. Next, in a step S20, a plurality of electric conductive fillers 110 are penetrated through the plurality of perforations 100 in a one-to-one manner, and a plurality of first electric conductive parts 111 and a plurality of second electric conductive parts 112 are formed on a first plane P1 and a second plane P2 of the plurality of electric conductive fillers 110, respectively, among which the first plane P1 and the second plane P2 are on two opposite sides of the electric conductive filler 110. Then, in a step S30, a reference sensing layer 12 is formed on one of the first electric conductive parts 111, and at least a chemical sensing layer 13 is formed on at least another one of the first electric conductive parts 111. Then, in a step S40, an electrolyte layer 14 is formed to cover over the reference sensing layer 12 and the chemical sensing layer 13.

In some embodiments, the electric conductive filler 110 may include but not limited to electric conductive silver layer. The first electric conductive parts 111 and the second electric conductive parts 112 may be sputtered metal films. The material of the first electric conductive parts 111 and the second electric conductive parts 112 may be selected from screen-printing silver-carbon electric conductive mixture slurry, gold paste, platinum paste, silver paste, electric conductive carbon slurry, gold, palladium, platinum, gold-palladium alloy or silver, but not limited herein.

The reference sensing layer 12 may be formed on the first electric conductive part 111 by for example but not limited to a drop-coating method, a sputtering method, an electrodeposition method or a screen-printing thick-film technique. Furthermore, the reference sensing layer 12 may be selected from a group consisting of silver (Ag), silver chloride (AgCl), mercury (Hg), mercury chloride (HgCl₂), iridium oxide (IrO₂), ruthenium oxide (RuO₂), platinum oxide (PtOₓ), palladium oxide (PdOₓ), tin oxide (SnO₂), tantalum oxide (Ta₂O₅), rhodium oxide (RhO₂), osmium oxide (OsO₂), titanium oxide (TiO₂), mercury oxide (Hg₂O) and antimony oxide (Sb₂O₃). In some embodiments, the reference sensing layer 12 is formed by silver (Ag) or silver chlorine (AgCl) through an electrochemical constant voltage method, but not limited thereto.

The modifying method of the chemical sensing layer 13 may be performed by electrophoresis, electroplating, impregnation, screen printing, dispensing, chemical vapor deposition, and physical vapor deposition. Furthermore, the chemical sensing layer 13 may be a total ammoniacal nitrogen sensing layer, a total dissolved solids content sensing layer, a dissolved oxygen sensing layer, a redox potential sensing layer, a nitrate sensing layer, a nitrite sensing layer, a pH value sensing layer, a calcium ion sensing layer, a potassium ion sensing layer, a magnesium ion sensing layer, a sodium ion sensing layer, a chloride ion sensing layer, a phosphate sensing layer, a pesticide sensing layer, or a heavy metal ion sensing layer, among which the heavy metal ion layer is used to sense nickel, copper, iron, zinc, manganese, bismuth, arsenic, lead, chromium, mercury and cadmium ions. In some embodiments, the chemical sensing layer 13 may also be an enzymatic sensing layer of human physiological parameters made by combining specific enzymes, such as a blood glucose sensing layer, a urea sensing layer, an uric acid sensing layer, a cholesterol sensing layer, a heavy metal ion sensing layer, a lactic acid sensing layer, a creatinine sensing layer and so on, but not limited herein.

The electrolyte layer 14 may be constructed by the materials of the liquid electrolytes, which may be for example but not limited to a hydrochloric acid aqueous solution, a potassium chloride aqueous solution, a potassium hydroxide aqueous solution, a sodium chloride aqueous solution, a phosphate buffer aqueous solution, a tris (hydroxymethyl) aminomethane (Tris) aqueous solution, a perchloric acid solution or a sulfuric acid solution. The concentration of the liquid electrolytes described above is ranged from 0.01 M to 0.1 M.

In some embodiments, the step S20 further comprises a step S21. In a step S21, a plurality of identification elements 18 are formed on the second surface S2 of the electric insulating base 10, and the plurality of identification elements 18 are disposed in a one-to-one manner corresponding to the plurality of electric conductive fillers 110.

In some embodiments, the step S20 further comprises a step S22. In the step S22, an insulating waterproof layer 15 is formed on the first surface S1 of the electric insulating base 10. The insulating waterproof layer 15 has a plurality of apertures 150 corresponding to the plurality of perforations 100, such that the plurality of first electric conductive parts 111 are exposed outside the insulating waterproof layer 15. The insulating waterproof layer 15 may be formed by for example but not limited to insulating and waterproof materials, such as a para-xylene polymer, a screen-printing insulating paste, or a screen printing UV insulating paste.

In some embodiments, the step S30 further comprises a step S31. In the step S31, a pad 16 having an opening 160 is provided, and the pad 16 is attached to the first surface S1 of the electric insulating base 10. Furthermore, the electrolyte layer 14 is accommodated in the opening 160, and is contacted with the reference sensing layer 12 and the chemical sensing layer 13. The pad 16 may be formed by for example but not limited to a polyethylene terephthalate (PET) or a poly vinyl chloride (PVC). In a preferred embodiment, 0.1 M aqueous solution of Tris (hydroxymethyl) aminomethane (Tris) may be used to set a fixed dispensing volume as 250 μL through a dispenser, and after filling the electrolyte filling area in the opening 160 of the pad 16, the preparation of the electrolyte layer 14 may be completed.

In some embodiments, the manufacture method of the array sensing electrode 1 of the present invention further comprises a step S50. In the step S50, a gas diffusion layer 17 is formed on the electrolyte layer 14, and the gas diffusion layer 17 is attached to the pad 16, so as to hold the electrolyte layer 14 among the gas diffusion layer 17 and the reference sensing layer 12 and the chemical sensing layer 13. The gas diffusion layer 17 is constructed by the material for example but not limited to a cellulose acetate, a silicone rubber, a polytetrafluoroethylene (PTFE), a copolymer of fluorinated ethylene propylene (FEP), a polydimethylsiloxane (PDMS), a polyvinyl chloride (PVC), a natural rubber or the combinations thereof.

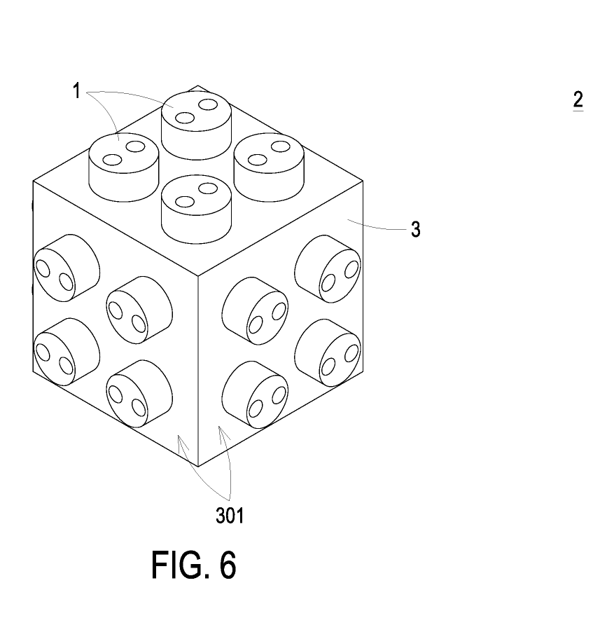

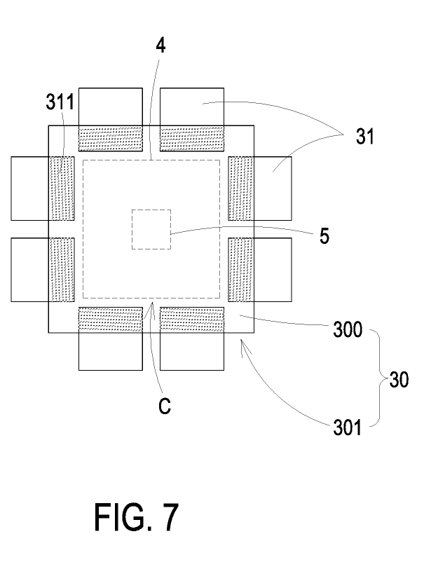

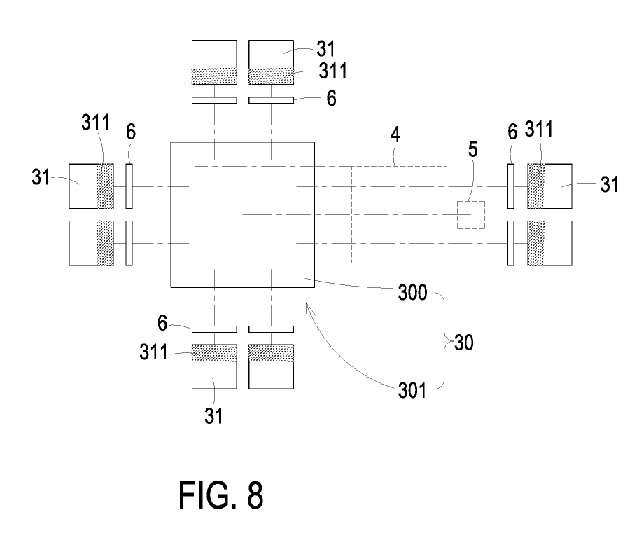

Please refer to FIG. 1, FIG. 3, FIG. 6, FIG. 7, and FIG. 8. FIG. 6 schematically illustrates a sensing platform according to an embodiment of the present invention. FIG. 7 schematically illustrates the bottom view of the sensing platform as shown in FIG. 6. FIG. 8 schematically illustrates the exploded structure of the sensing platform as shown in FIG. 7. As shown in FIG. 1, FIG. 3, FIG. 6, FIG. 7, and FIG. 8, the sensing platform 2 of the present invention comprises a housing 3, a circuit board 4, a control unit 5, and a plurality of array sensing electrodes 1. The housing 3 has an outer wall 30 and a plurality of carrier channels 31, and the outer wall 30 is closed to form an accommodation space C in the housing 3. The circuit board 4 is disposed in the accommodation space C, the control unit 5 is disposed on the circuit board 4, and each of the array sensing electrodes 1 is embedded in one of the plurality of carrier channels 31. The array sensing electrodes 1 in the sensing platform 2 may be anyone of the foregoing embodiments, and the details are not described herein. Furthermore, the second electric conductive part 112 of the array sensing electrodes 1 is electrically connected with the control unit 5.

In some embodiments, the control unit 5 may further comprises a multi-function module and a vibration control module (not shown). The vibration control module is powered and is connected to the multi-function module, the control unit 5 and the circuit board 4, so as to generate each oscillation waveform corresponding to the conduction on the circuit board 4 by using an operating voltage or current, and send it to the array sensing electrode 1, but not limited herein.

In some embodiments, the outer wall 30 of the housing 3 comprises a flat sidewall 300 and a plurality of support sidewalls 301, and the carrier channels 31 are distributed on the support sidewalls 301, but not limited thereto. In some embodiments, each of the carrier channels 31 has a threaded portion 311, so that each of the array sensing electrodes 1 is screwed to the threaded portion 311. In some embodiments, the sensing platform 2 may further comprise a plurality of elastic sealing sleeves 6 disposed on the housing 3. The elastic sealing sleeves 6 and the array sensing electrodes 1 may be fixed on the carrier channels 31 by the cooperation of the threaded portions 311 and the fasteners. In some embodiments, the carrier channels 31 may be a circular, columnar, or polygonal structure, and the housing 3 may be made of acrylic or glass, but not limited thereto.

In brief, in the sensing platform of the present invention, by disposing a housing with a plurality of carrier channels, disposing the circuit board in the accommodation space of the housing, and embedding the array sensing electrodes in the plurality of carrier channels to be electrically connected to the control unit, the housing may carry a plurality of sensing electrodes, thereby being conducive to packaging and achieving waterproof effects.

From the above description, the present invention provides an array sensing electrode, a manufacturing method thereof and a sensing platform. Through making the electric conductive fillers of the plurality of electric conductive assemblies to be penetrated through the electric insulating base, and disposing the reference sensing layers and the chemical sensing layers on the electric conductive assemblies, the sensitivity of the chemical sensing is enhanced, the manufacture is simplified, and the size of the electrode is reduced. Furthermore, by making the plurality of electric conductive fillers to be penetrated through the plurality of perforations of the electric insulating base, disposing the first electric conductive part, which is used to dispose the sensing layers, on the first plane of the electric conductive filler, and disposing the second electric conductive part connected to the control unit on the second plane of the electric conductive filler, the volume of the electrode is decreased, and the advantages of reducing the manufacturing cost and being conductive to the package are achieved. Meanwhile, through disposing the plurality of identification elements in a one-to-one manner corresponding to the plurality of electric conductive assemblies on the second surface of the electric insulating base, so as to identify the electric conductive assemblies with different sensing layers while the sensing electrode is in operation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An array sensing electrode, comprising:
an electric insulating base having a first surface, a second surface, and a plurality of perforations, wherein the first surface and the second surface are on two opposite sides of the electric insulating base, and the first surface and the second surface are communicated by the plurality of perforations;
a plurality of electric conductive assemblies, each electric conductive assembly comprising:
an electric conductive filler penetrated through one of the plurality of perforations, wherein the electric conductive filler has a first plane and a second plane, which are on two opposite sides of the electric conductive filler;
a first electric conductive part disposed on the first plane of the electric conductive filler; and
a second electric conductive part disposed on the second plane of the electric conductive filler;
a reference sensing layer disposed on the first electric conductive part of one of the plurality of electric conductive assemblies;
at least a chemical sensing layer disposed on the first electric conductive part of at least another one of the plurality of electric conductive assemblies; and
an electrolyte layer disposed on and covering the reference sensing layer and the chemical sensing layer.

2. The array sensing electrode according to claim 1, further comprising an insulating waterproof layer disposed on the first surface of the electric insulating base, wherein the insulating waterproof layer has a plurality of apertures corresponding to the plurality of perforations, such that the first electric conductive parts are exposed outside the insulating waterproof layer.

3. The array sensing electrode according to claim 1, further comprising a pad disposed on the first surface of the electric insulating base, wherein the pad has an opening, and the electrolyte layer is accommodated in the opening and contacted with the reference sensing layer and the chemical sensing layer.

4. The array sensing electrode according to claim 3, further comprising a gas diffusion layer disposed on and covering the electrolyte layer, and attached to the pad for holding the electrolyte layer among the gas diffusion layer and the reference sensing layer and the chemical sensing layer.

5. The array sensing electrode according to claim 1, further comprising a plurality of identification elements disposed on the second surface of the electric insulating base, wherein the plurality of identification elements are disposed in a one-to-one manner corresponding to the plurality of electric conductive assemblies to perform the identification.

6. A manufacturing method of an array sensing electrode, comprising steps of:
(a) providing an electric insulating base, wherein the electric insulating base has a first surface, a second surface, and a plurality of perforations, wherein the first surface and the second surface are on two opposite sides of the electric insulating base, and the first surface and the second surface are communicated by the plurality of perforations;
(b) making a plurality of electric conductive fillers to be penetrated through the plurality of perforations in a one-to-one manner and forming a plurality of first electric conductive parts and a plurality of second electric conductive parts on a first plane and a second plane of the plurality of electric conductive fillers, respectively, wherein the first plane and the second plane are on two opposite sides of the electric conductive filler;
(c) forming a reference sensing layer on one of the first electric conductive parts and forming at least a chemical sensing layer on at least another one of the first electric conductive parts; and
(d) forming an electrolyte layer to cover the reference sensing layer and the chemical sensing layer.

7. The manufacturing method of the array sensing electrode according to claim 6, wherein the chemical sensing layer is a total ammoniacal nitrogen sensing layer, a total dissolved solids content sensing layer, a dissolved oxygen sensing layer, a redox potential sensing layer, a nitrate sensing layer, a nitrite sensing layer, a pH value sensing layer, a calcium ion sensing layer, a potassium ion sensing layer, a magnesium ion sensing layer, a sodium ion sensing layer, a chloride ion sensing layer, a phosphate sensing layer, a pesticide sensing layer, or a heavy metal ion sensing layer, wherein the heavy metal ion layer is used to sense nickel, copper, iron, zinc, manganese, bismuth, arsenic, lead, chromium, mercury and cadmium ions, and wherein the reference sensing layer is selected from a group consisting of silver, silver chlorine, mercury, mercury chloride, iridium oxide, ruthenium oxide, platinum oxide, palladium oxide, tin oxide, tantalum oxide, rhodium oxide, osmium oxide, titanium oxide, mercury oxide and antimony oxide.

8. The manufacturing method of the array sensing electrode according to claim 6, wherein the step (b) further comprises a step (b1): forming a plurality of identification elements on the second surface of the electric insulating base and making the plurality of identification elements to be disposed in a one-to-one manner corresponding to the plurality of electric conductive fillers.

9. The manufacturing method of the array sensing electrode according to claim 8, wherein the step (b) further comprises a step (b2): forming an insulating waterproof layer on the first surface of the electric insulating base, and wherein the insulating waterproof layer has a plurality of apertures corresponding to the plurality of perforations, such that the plurality of first electric conductive parts are exposed outside the insulating waterproof layer.

10. The manufacturing method of the array sensing electrode according to claim 9, wherein the step (c) further comprises a step (c1): providing a pad having an opening, attaching the pad to the first surface of the electric insulating base, and making the electrolyte layer to be accommodated in the opening and to be contacted with the reference sensing layer and the chemical sensing layer.

11. The manufacturing method of the array sensing electrode according to claim 10, further comprising a step (e): forming a gas diffusion layer on the electrolyte layer and attaching the gas diffusion layer to the pad, so as to hold the electrolyte layer among the gas diffusion layer and the reference sensing layer and the chemical sensing layer.

12. A sensing platform, comprising:
a housing having an outer wall and a plurality of carrier channels, wherein the outer wall is closed to form an accommodation space in the housing;
a circuit board disposed in the accommodation space;
a control unit disposed on the circuit board; and
a plurality of array sensing electrodes, wherein each of the array sensing electrodes is embedded in one of the plurality of carrier channels, comprising:
an electric insulating base having a first surface, a second surface, and a plurality of perforations, wherein the first surface and the second surface are on two opposite sides of the electric insulating base, and the first surface and the second surface are communicated by the plurality of perforations;
a plurality of electric conductive assemblies, each electric conductive assembly comprising:
an electric conductive filler penetrated through one of the plurality of perforations, wherein the electric conductive filler has a first plane and a second plane, which are on two opposite sides of the electric conductive filler;
a first electric conductive part disposed on the first plane of the electric conductive filler; and
a second electric conductive part disposed on the second plane of the electric conductive filler and electrically connected with the control unit;
a reference sensing layer disposed on the first electric conductive part of one of the plurality of electric conductive assemblies;
at least a chemical sensing layer disposed on the first electric conductive part of at least another one of the plurality of electric conductive assemblies; and
an electrolyte layer disposed on and covering the reference sensing layer and the chemical sensing layer.

13. The sensing platform according to claim 12, wherein the outer wall comprises a flat sidewall and a plurality of support sidewalls, and wherein the plurality of carrier channels are distributed on the support sidewalls.

14. The sensing platform according to claim 12, wherein each of the carrier channels has a threaded portion, so that each of the array sensing electrodes is screwed to the threaded portion.
